(19) United States
(12) Patent Application Publication
(10) Pub. No.: US 2023/0108142 A1
(43) Pub. Date: Apr. 6, 2023

(54) ROBOTIC BRACE AND METHODS OF MANUFACTURE THEREOF

(71) Applicant: University of Connecticut, Farmington, CT (US)

(72) Inventors: Cato Laurencin, Avon, CT (US); Godwin Dzidotor, Manchester, CT (US); Yusuf Khan, Hamden, CT (US); Seyed Amir Seyedsalehi, Vernon, CT (US)

(21) Appl. No.: 17/961,416

(22) Filed: Oct. 6, 2022

Related U.S. Application Data
(60) Provisional application No. 63/252,880, filed on Oct. 6, 2021.

(51) Int. Cl. A61H 1/02

(52) U.S. Cl. CPC A61H 1/024; A61H 2201/165; A61H 2201/1238; A61H 2201/1673; A61H 2201/1659

(57) ABSTRACT

Disclosed herein is a brace for regeneration of tissue in a knee comprising a sleeve and a first strut; where the first strut comprises an upper portion comprising a first jig; where the first jig comprises a slot for hosting a first strap that is in contact with the sleeve; a central portion that comprises a central strut that is in fluid communication with an actuator located on a first side of the knee that imposes a force on the knee; where the force is inclined at an angle to a longitudinal axis of the first strut; and a lower portion that comprises a second jig; where the second jig comprises a slot for hosting a second strap that contacts the sleeve at an opposite end relative to a position that the first strap contacts the sleeve.

### CROSS-REFERENCE TO RELATED APPLICATIONS

This application claims priority to U.S. Provisional Application No. 63/252,880 filed on Oct. 6, 2021, the entire contents of which are hereby incorporated in their entirety.

### STATEMENT OF GOVERNMENTAL SUPPORT

This invention was made with government support under 1844660 awarded by the National Science Foundation. The government has certain rights in the invention.

### BACKGROUND OF THE DISCLOSURE

This disclosure relates to a robotic brace and to methods of manufacture thereof. In particular, this disclosure relates to a soft-actuated robotic brace and to methods of manufacture thereof.

Regeneration of articular cartilage is an unmet clinical need that affects a large population worldwide. A current approach to addressing this problem is the use of unloader braces, which are rigid structures that do not provide for cartilage regeneration. Some patients tend to seek pharmacological remedies such as the use of oral analgesics, NSAIDs and intra-articular injection as short-term approaches to alleviating pain. End-stage remedies include surgical procedures such as partial or total knee arthroplasty.

Based on the foregoing, a need exists for addressing at least regeneration of articular cartilage.

### SUMMARY OF THE DISCLOSURE

Disclosed herein is a brace for regeneration of tissue in a knee comprising a sleeve and a first strut; where the first strut comprises an upper portion comprising a first jig; where the first jig comprises a slot for hosting a first strap that is in contact with the sleeve; a central portion that comprises a central strut that is in fluid communication with an actuator located on a first side of the knee that imposes a force on the knee; where the force is inclined at an angle to a longitudinal axis of the first strut; and a lower portion that comprises a second jig; where the second jig comprises a slot for hosting a second strap that contacts the sleeve at an opposite end relative to a position that the first strap contacts the sleeve.

Disclosed herein too is a brace for regeneration of tissue in a knee comprising a sleeve; at least two a soft bodied actuators; where the two soft bodied actuators are located on diametrically opposing sides of the sleeve; where the ends of each soft bodied actuators are located at the opposing longitudinal ends of the sleeve; where each soft bodied actuator comprises an elastomer; where each soft bodied actuator comprises a plurality of chambers; where each chamber comprises an internal cavity that is in fluid communication with a central channel and where the central channel is in fluid communication with an inlet port; where the length of the soft bodied actuator is increased by increasing the internal air pressure inside the plurality of chambers.

### BRIEF DESCRIPTION OF THE FIGURES

FIG. 1 depicts one embodiment of the soft brace that may be activated automatically loaded to unload pressure on the knee joint of a patient;

FIG. 2 depicts an enlarged section of the upper portion of the strut;

FIG. 3A is an expanded view of the upper portion that comprises portions and of the first strut taken along section XX′ in FIG. 1;

FIG. 3B depicts an expanded view of the device that is effective to actuate the first actuator;

FIG. 3C is an enlarged view of the central portion;

FIG. 4 is a cross-sectional view of the central portion taken along Section 4-4;

FIG. 5 is an exemplary depiction of the expansion of the actuator bladder, which promotes distraction of the femur and shank (or tibia) to permit rehabilitation of the cartilage at the knee;

FIG. 6 is a depiction of the lower portion of the brace;

FIGS. 7A and 7B depict one manner of using the brace;

FIGS. 8A and 8B depict one exemplary embodiment of a soft bodied actuator; and

FIG. 9 depicts the manner of using the soft bodied actuator.

### DETAILED DESCRIPTION OF THE DISCLOSURE

Disclosed herein is a design for a soft brace that facilitates cartilage regeneration at a joint such as, for example, the knee. The present disclosure describes a bioactive dynamic soft-actuated robotic brace. The brace described herein may be transformative in treating/rehabilitating musculoskeletal diseases (e.g., osteoarthritis), valgus- or varus-deformity, injuries, and related joint injuries/diseases.

The brace presents a non-invasive approach to treating degenerated articular cartilage at, for example, the knee where it can facilitate cartilage regeneration between the femur (of the thigh) and the two bones of the lower leg namely the tibia and the fibula. The brace's distraction mechanism helps unload pressure on the knee joint of a patient who may be suffering from an injury/disease. The mentioned distraction mechanism provides the knee joint with the appropriate loading for optimal cartilage repair. It should be understood that although a knee joint may be used to further describe the brace assembly noted herein, the features of the brace assembly may be applied to other human and animal joints. The use of a knee joint is not intended to be limiting and is merely a way to apply the described brace to applications.

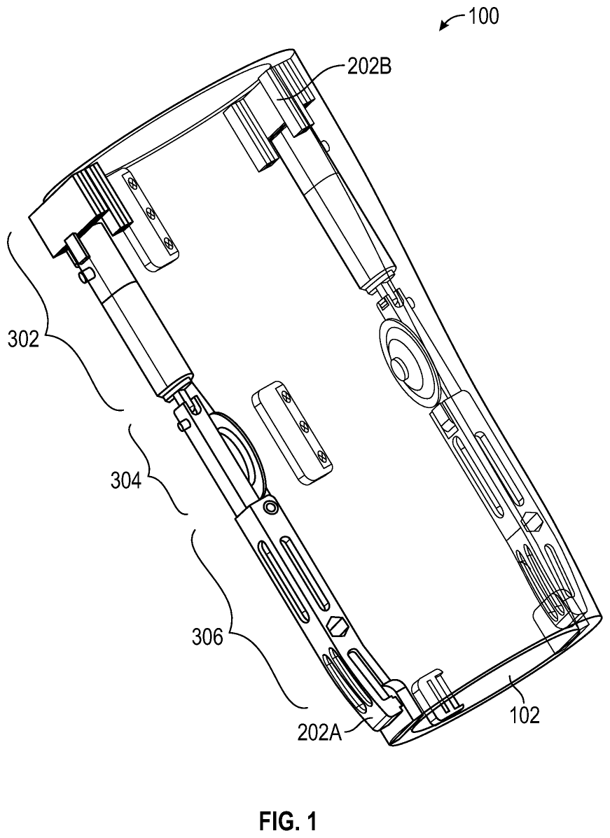

FIG. 1 depicts one embodiment of the soft brace 100 that may be activated automatically loaded to unload pressure on the knee joint of a patient. The soft brace 100 comprises and elastic sleeve 102 that fits snugly on the leg of the patient. The sleeve 102 contains locations for the attachment of straps that can contact the leg at the upper end (femur), middle (knee joint) and lower end (tibia) of the brace (not shown in FIG. 1). The elastic sleeve 102 also supports at least one strut 202A that comprises one or more actuators that provide a mechanism for distraction of the knee joint with the appropriate loading for optimal cartilage repair. In an embodiment, the sleeve 102 can support at least two struts 202A and 202B (one on the left side of the knee and one on the right side of the knee; these struts are opposedly disposed to each other) each of which contain at least one actuator that provides a mechanism for distraction of the knee joint with the appropriate loading for optimal cartilage repair. The struts will now be described with reference to strut 202A and this description applies equally to strut 202B. The struts 202A and/or 202B together with the sleeve 102 form the soft brace 100.

The strut 202A will now be described in detail. Strut 202B is essentially the same as strut 202A and it will not be described here in detail in the interests of brevity. Only those features of strut 202B relevant to the operation of the brace will be described when warranted.

Strut 202A comprises an upper portion 302 that contacts the leg above the knee and that optionally comprises a first actuator, a central portion 304 that contacts the leg in the knee region and comprises a second actuator and a lower portion 306 that contacts the leg below the knee. In this embodiment, at least one structural member of the upper portion, the central portion and the lower portion are manufactured from a rigid material. A rigid material is one which will undergo yield upon the application of a deforming force.

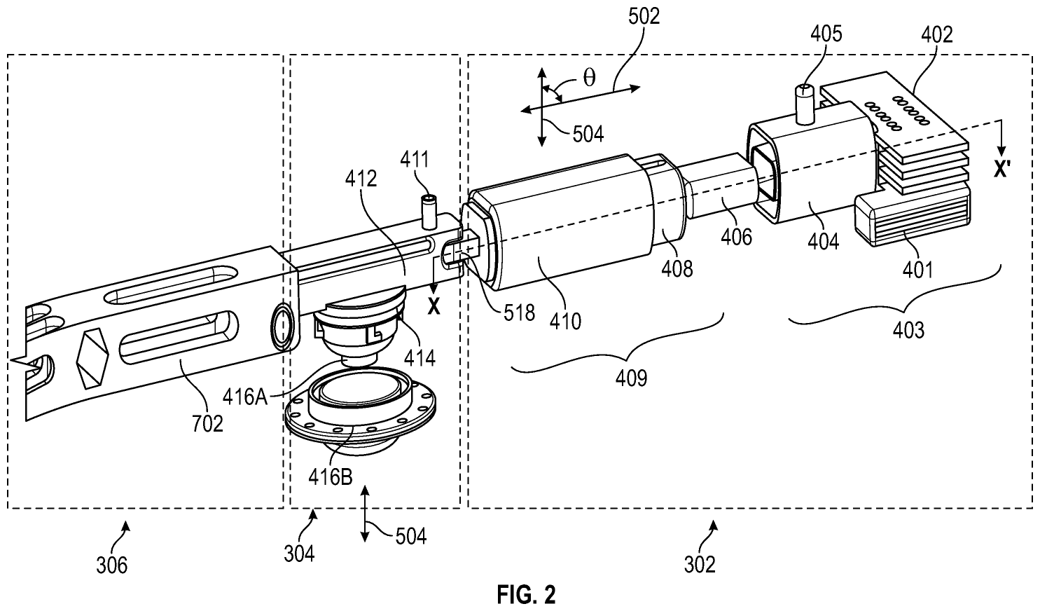

FIG. 2 depicts an enlarged section of the upper portion 302 of the strut 202A. The upper portion 202 of the strut 202A comprises a first jig 403 at one end. The first jig 403 contains a strap hole 401 through which at least one strap (not shown) that facilitates attaching the brace (via the sleeve) to the leg is placed. The end at which the first jig 403 is located is generally the upper end of the strut 202A, though it could be deployed at the lower end of the strut 202A. The first jig 403 comprises a strap holder 402 located proximate to an actuator housing 404 that contains an air inlet port 405. The actuator housing 404 is located adjacent to an optional actuating chamber 406 that houses the optional first actuator (not shown). Pressurized air that is transmitted through the inlet port 405 is used to activate the first actuator. The first actuator supplies a first force that increases the total length of the strut 202A (in the longitudinal direction — where the longitudinal direction is parallel to a direction of the length of the leg from the thigh to the foot) thus facilitating a portion of the effort to distract the cartilage at the knee to enable its growth and repair. The longitudinal axis of the struts 202A and 202B are assumed to be substantially similar in direction to the direction of the length of the leg. This first force is an extensional or elongational force that acts in a first direction represented by arrow 502 along the length of the leg. The lateral direction is a direction substantially perpendicular to the longitudinal direction.

The actuating chamber contacts an actuator shell 409 that comprises a first actuator shell 408 in slidable communication with a second actuator shell 410. The first actuator shell 408 is arranged in a telescoping arrangement with the second actuator shell 410 and can move in an out of the second actuator shell 410 to change the length of the strut 202A when desired.

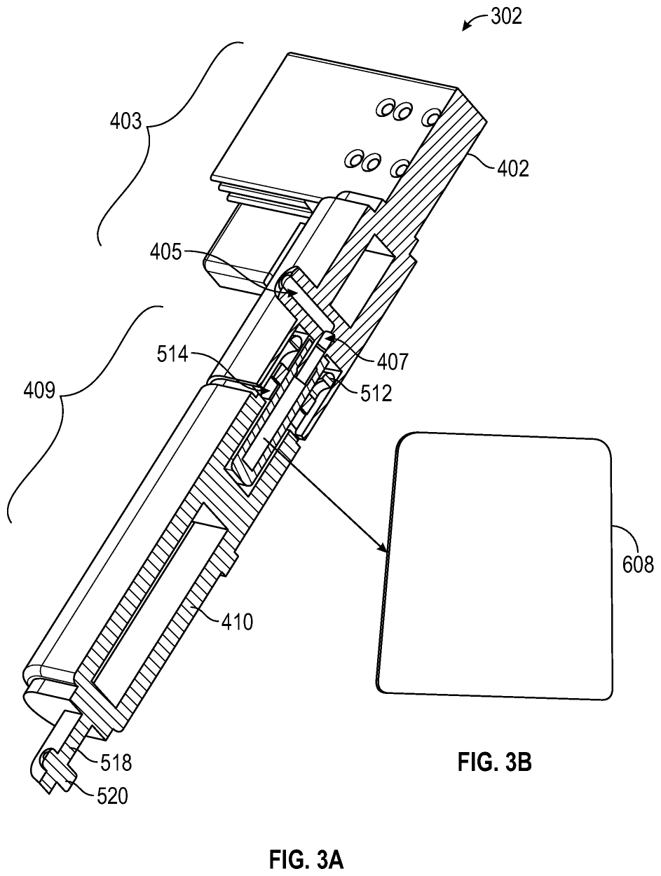

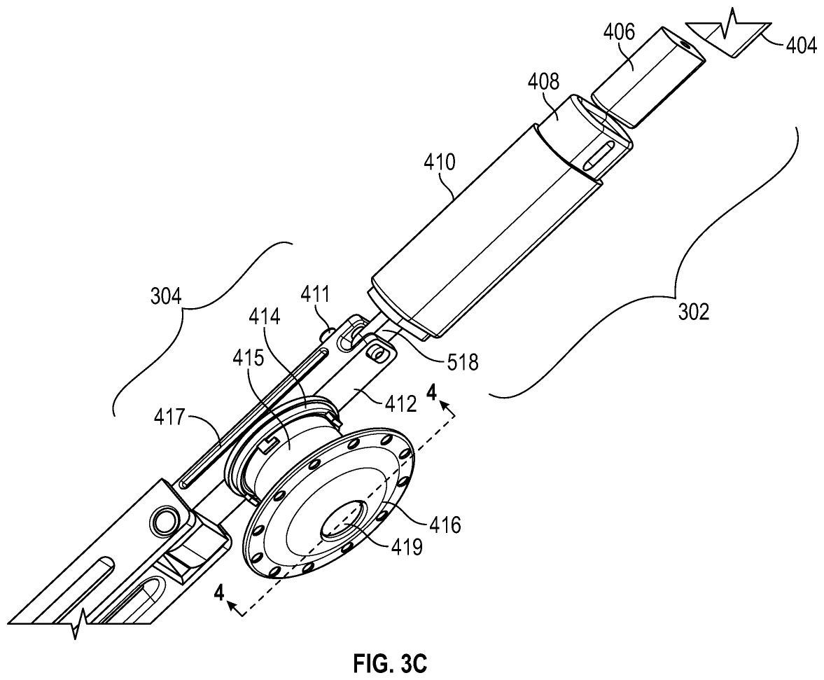

FIG. 3A is an expanded view of the upper portion 302 that comprises portions 403 and 409 of the first strut 202A taken along section XX′ in FIG. 1. FIG. 3B depicts an expanded view of the device that is effective to actuate the first actuator 608. In FIG. 3B, it may be seen that the inlet port 405 is in fluid communication with conduit 407 that communicates with the chamber that contains first actuator 608. The first actuator 608 is an elastomeric pouch that expands upon being filled with pressurized air. Upon expanding, the first actuator 608 causes the portion 403 to move away from portion 409, thus extending the length of the strut 202A. The inlet port 405 may be sealed (not shown) to prevent the pressurized air from escaping. Alternatively, the inlet port 405 may contain a one-way valve which prevents air from escaping from the first actuator 608 to the outside of the strut 202A.

When pressurized air is forced into the first actuator 608, it expands in length forcing portion 403 to travel along a guide rail 514 and move away from portion 409. Guide rails 514 may be replaced with splines or some other form of guidance to permit the portion 409 to travel back and for the with portion 403 while not losing alignment. The actuator shell 410 contacts the central portion 304 through a swivel pin 518 having two protrusions 520 about the pin 518, which permits the central portion 304 and the upper portion 302 to swivel about each other. This swiveling permits the knee to move forward and backward (to and fro) when the brace is placed on the leg.

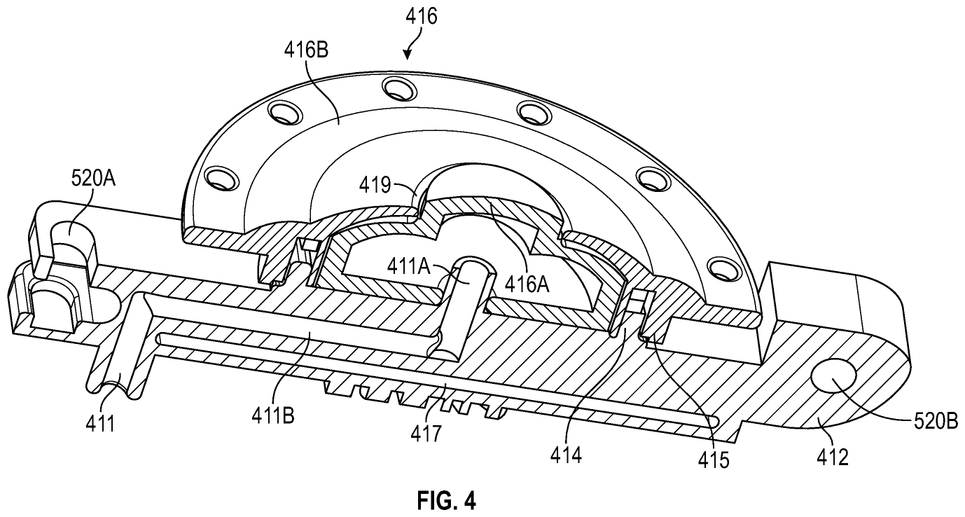

FIG. 3C is an enlarged view of the central portion 304. FIG. 4 is a cross-sectional view of the central portion 304 taken along Section 4-4. Section 4-4 extends into the plane of the paper. With reference now once again to the FIGS. 1, 2, 3C and 4, as noted above, the upper portion 302 of the strut 202A contacts the central portion 304 of the strut 202A. The central portion 304 comprises a central strut 412 (also referred to herein as a central beam 412) that is in fluid communication with a second actuator 416 that imposes a second force 504 on the knee that is inclined at an angle θ to the direction of the first force 502. In an exemplary embodiment, the first force 502 is inclined at an angle of 80 to 100 degrees, preferably 85 to 95 degrees to the second force 504. In a preferred embodiment, the first force 502 is at a right angle to the second force 504 (i.e., the first force 502 acts in a longitudinal direction, while the second force 504 acts in a lateral direction).

The second actuator 416 comprises an actuator shell 416B (see FIG. 4) that encompasses an actuator bladder 416A. The actuator bladder 416A is in fluid communication with the inlet port 411 situated on the central strut 412 that functions as the load bearing member of the central portion 304. The inlet port 411 is in fluid communication with a conduit 411B that lies in the central strut 412 (the central beam 412). The conduit 411B is in fluid communication with the outlet port 411C that lies in an inner portion of the strut 412. The outlet port 411C opens into the actuator bladder 416A.

The actuator bladder 416A comprises an elastomeric material and can be formed of the same elastomeric material as the first actuator 608 (see FIGS. 3A and 3B) of the upper portion 302 of the brace 100. The elastomeric material is preferably a material that is compatible with the skin of a living being and is inert to atmospheric elements such as oxygen and moisture. The elastomeric material preferably can return to its original shape and size upon removal of a deforming force.

The elastomeric material may comprise a polysiloxane, a polybutadiene, a polyisoprene, a styrene-butadiene rubber, a poly(styrene)-block-poly(butadiene), a poly(acrylonitrile)-block-poly(styrene)-block-poly(butadiene) (ABS), a polychloroprene, an epichlorohydrin rubber, a polyacrylic rubber, a fluorosilicone elastomer, a fluoroelastomer, a perfluoroelastomer, a polyether block amide (PEBA), a chlorosulfonated polyethylene, an ethylene propylene diene rubber (EPR), an ethylene-vinyl acetate elastomer, or a combination thereof. In an exemplary embodiment, the elastomer is preferably manufactured from a polysiloxane, a perfluoroelastomer, a fluoroelastomer, or a combination thereof.

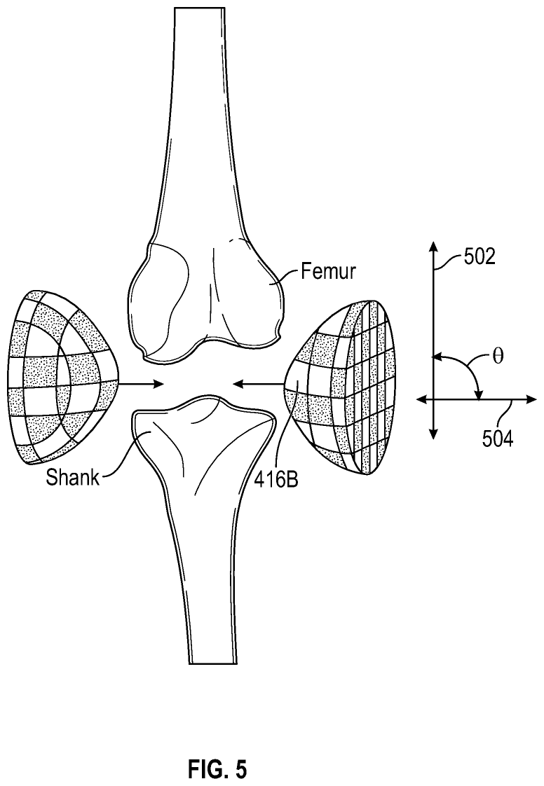

Pressurized air can be entered into the actuator bladder 416A causing it to expand laterally in a direction 504 (see FIG. 2) that is inclined at the angle θ to the direction 502. The direction 502 is also termed the longitudinal direction, while the direction 504 is termed the lateral direction. FIG. 5 is an exemplary depiction of the expansion of the actuator bladder 416A, which promotes distraction of the femur and shank (or tibia) to permit rehabilitation of the cartilage at the knee. By activating the first actuator 608 and the second actuator 416, the distraction mechanism helps unload pressure on the knee joint of a patient who may be suffering from an injury/disease. This distraction mechanism provides the knee joint with the appropriate loading for optimal cartilage repair.

With reference now to FIG. 3C and 4, the actuator bladder 416A is surrounded by the actuator shell 416B. The actuator shell 416B protects the actuator bladder 416A from accidental rupturing and also provides the device with an acceptable tactile finish that prevents the skin from getting agitated due to continuous contact. The actuator shell 416B can be reversibly fixed to the central strut 412. It can be screwed on or twisted onto latches 414.

The actuator shell 416B contains a central passage 419 through which actuator bladder 416A protrudes to contact the skin. The presence of the central passage permits the protrusion of the actuator bladder 416A to be focused at the knee. This permits the pressure to be applied at a point source (focused) in the knee. The actuator shell 416B is significantly stiffer than the actuator bladder 416A and surrounds the actuator bladder 416A except for the central passage 419 where the actuator bladder 416A can protrude through. The base of the actuator shell 415 can be attached to the central strut 412. This attachment is a reversible attachment and the actuator shell can be screwed on or twisted on, but removed when desired. It is to be noted that the actuator bladder 416A in the first strut 202A and the second strut 202B (see FIG. 1) act in opposing directions that compressing the knee and distracting the tissue in the knee to improve chances of them being repaired and rehabilitated. As noted above, the first strut 202A and the second strut 202B are the same as each other, but face opposite directions. This permits the actuator bladder 416A on the first strut and the corresponding actuator bladder on the second strut to act in opposite directions to exert a compressive stress on the knee. (see FIG. 1)

The central strut 412 contains first opposing openings 520A in the frame that accommodates the protrusions 520 of the swivel pin 518. The protrusions 520 of the swivel pins 518 are placed in the first opposed openings 520A and permit the upper portion 302 and the lower portion 304 of the brace 100 to swivel back and forth.

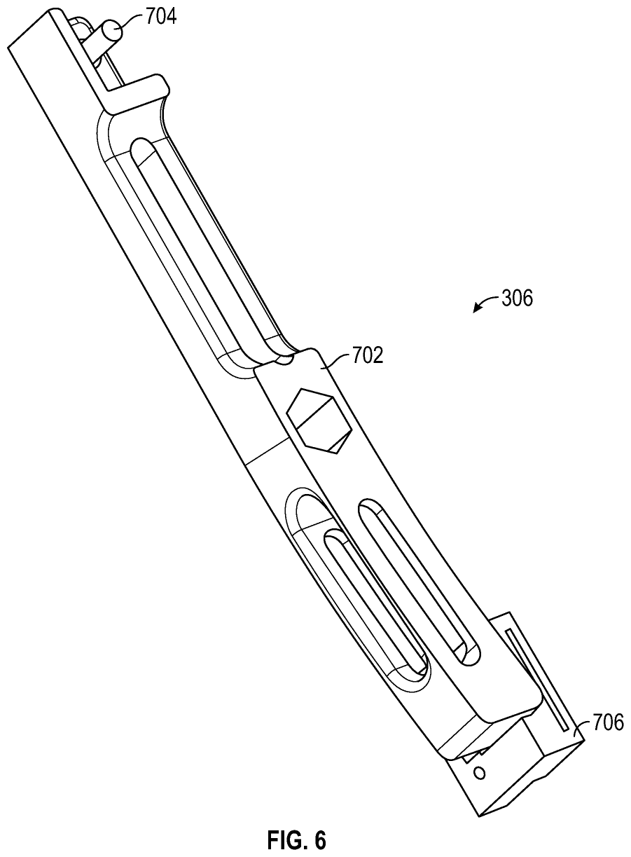

The central strut 412 also contains a second opening 520B (See FIG. 4) which contacts a pin 704 contained in the lower strut 702 as seen in the FIGS. 2 and 6. FIG. 6 is a depiction of the lower portion 306 of the brace 100. The pin 704 is disposed in the second opening 520B and permits the central strut 412 and the lower strut 702 to be in rotary motion (swiveling motion) with each other.

The second opening 520B lies at the opposite end of the central strut 412 from the first opposing openings 520A. The second opening 520B permits the central strut 412 to be attached to the lower strut 702 (also called a lower beam 702) from the lower portion 306 that contacts the leg below the knee. The lower portion 306 and the central portion 304 can therefore swivel about each other.

The lower strut 702 has at its lower end (the end opposite the end that contains the pin 704) a second jig 706, which contains a slot 708 through which a third strap (not shown) can pass.

The structures of the upper portion 302, the central portion 304 and the lower portion 306 may be manufactured from a metal, a ceramic, a polymer, or a combination thereof. In an embodiment, the metal may be a lightweight metal such as aluminum. A variety of different polymers may be used to manufacture the various structures shown in the figures. The polymer is preferably one that can withstand atmospheric conditions without swelling or deterioration. Polymeric composites with carbon or glass fibers may also be used. Examples of suitable polymers include polyolefins, polytetrafluoroethylene, polysiloxane copolymers, or the like, or a combination thereof.

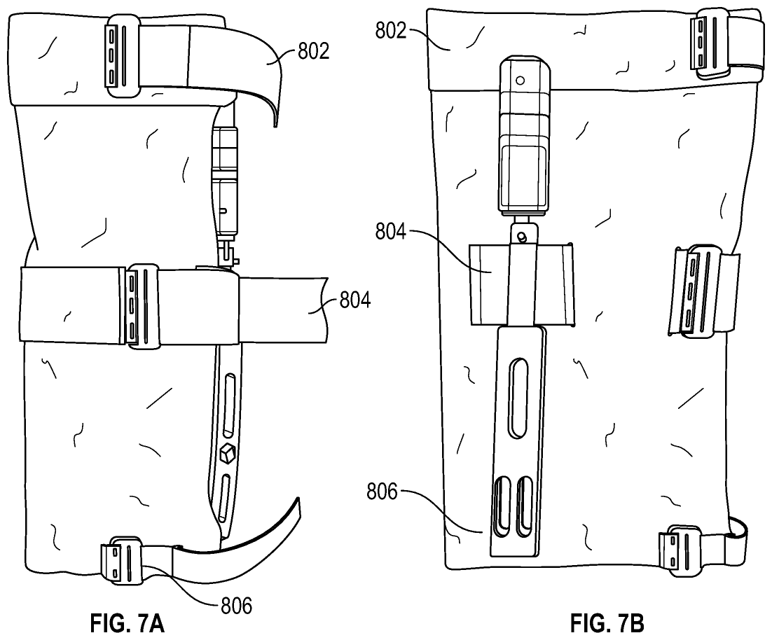

In one embodiment, in one manner of using the brace 100 of the FIGS. 1-6, the brace 100 may be disposed on the leg of a patient whose knee is in need of rehabilitation and recuperation. FIGS. 7A and 7B depict one manner of using the brace 100. A first strap 802 is wound through strap holder 402 of the first jig 403. (See FIGS. 1 and 2). The strap 802 may contain Velcro (not shown) in order to prevent slippage after its is wrapped around the sleeve 102 and the sleeve is wrapped around the leg of the patient. (See FIGS. 1 and 2) Similarly straps 804 (which is wound through strut 412-see FIG. 3C) and 806 (which is wound through the second jig 706—See FIG. 6) may be wrapped around the sleeve when it is place on the leg of the patient.

The first actuator contained in the actuator housing 406 (in both struts 202A and 202B-see FIG. 2) and the second actuator 416B (contained in both struts 202A and 202B-see FIGS. 2 and 4) may be deployed by increasing air pressure in the actuator. The first actuator acts in the direction 502 (see FIGS. 2 and 5) is operative to increase the distance between the bones in the thigh (e.g., the femur) and the bones in the lower leg (e.g., the tibia and shank) thus reducing the load on the cartilage in the knee. The second actuator acts in the direction 504 (see FIGS. 2 and 5) and compresses the knee (see FIG. 5) thus distracting the knee joint with the appropriate loading and permitting for optimal cartilage repair.

In summary, a brace for regeneration of tissue in a knee comprises a sleeve with a first strut 202A and a second strut 202B. The first strut comprises an upper portion comprising a first jig; where the first jig comprises a slot for hosting a first strap that is in contact with the sleeve. The central portion of both struts 202A and 202B comprises a central strut that is in fluid communication with an actuator located on a first side of the knee that imposes a force on the knee; where the force is inclined at an angle to a longitudinal axis of the first strut 202A or the second strut 202B. Both struts 202A and 202B each comprise a lower portion that comprises a second jig. The second jig comprises a slot for hosting a second strap that contacts the sleeve at an opposite end relative to a position that the first strap contacts the sleeve.

The second strut that lies opposite the first strut on the sleeve. As noted above, the second strut also comprises a central portion that comprises a central strut in fluid communication with an actuator located on a second side of the knee that imposes a force on the knee; where the force is inclined at an angle to a longitudinal axis of the second strut. The actuator on the second side of the knee applies a force that is opposed to the force applies by the actuator on the first side of the knee.

The first jig is in contact with an actuator chamber that contains an actuator that increases a length of the first strut; where the actuator contained in the actuator chamber imposes a force along the longitudinal axis of the strut. The second strut also comprises an upper portion that is in communication with the central portion, where the upper portion comprises a jig and an actuator contained in an actuation chamber; where the actuator imposes a force along the longitudinal axis of the second strut.

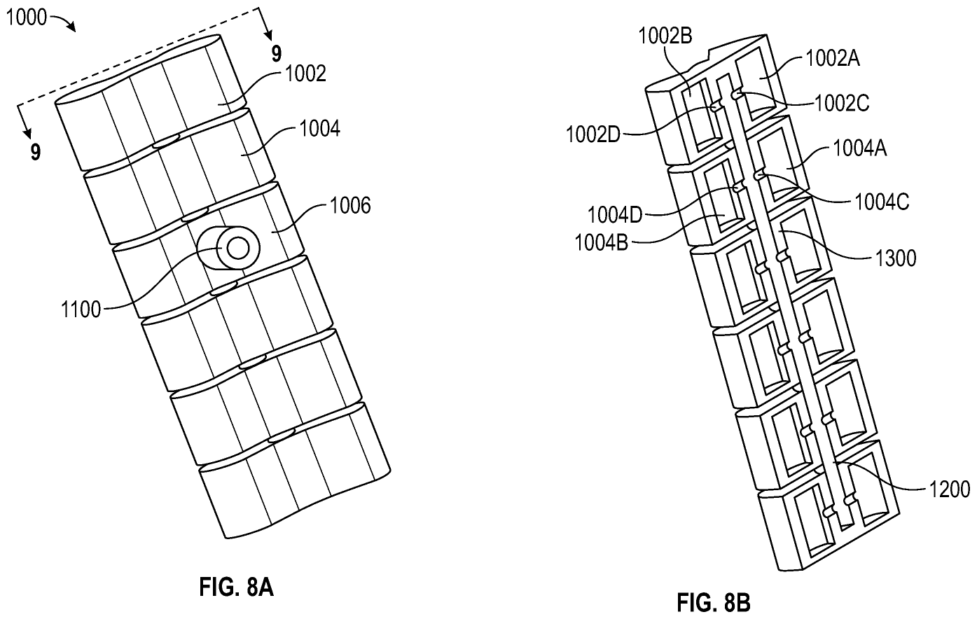

In another embodiment, the struts 202A and 202B may be manufactured from a lightweight flexible material that contains no rigid portions. The rigid supports of upper portion 302, the central portion 304 and the lower portion 306 may be replaced with soft-bodied bionic actuators. FIGS. 8A and 8B depict one exemplary embodiment of a soft bodied actuator 1000.

The actuator 1000 comprises a plurality of chambers 1002, 1004, 1006, . . . and so on that are in fluid communication with an inlet port 1100 as seen in the FIG. 8A. The input port 1100 is in fluid communication with a central channel 1200 as seen in the FIG. 8B. The FIG. 8B is a sectional view taken along section ZZ′. It depicts each chamber 1002 as having two internal cavities 1002A and 1002B that are in fluid communication with the central channel 1200 via inlet ports 1002C and 1002D respectively. Each chamber comprises a cavity and the cavities are in fluid communication with one another. The walls of the central channel 1200 are non-retractable —i.e., it cannot shrink to a size smaller than its original size in the temperature range of operation.

In operation, the opposing ends of the soft bodied actuator are held in position by straps that are attached to a sleeve. A sleeve that is used as a part of the brace may contain at least two a soft bodied actuators—where the two soft bodied actuators are located on diametrically opposing sides of the sleeve. One of the actuators may be located on the left side of the knee, while the other actuator is located in an opposite position on the right side of the same knee. The ends of each soft bodied actuators are located at the opposing longitudinal ends of the sleeve. They may be fixedly attached via straps to the opposing longitudinal ends of the sleeve.

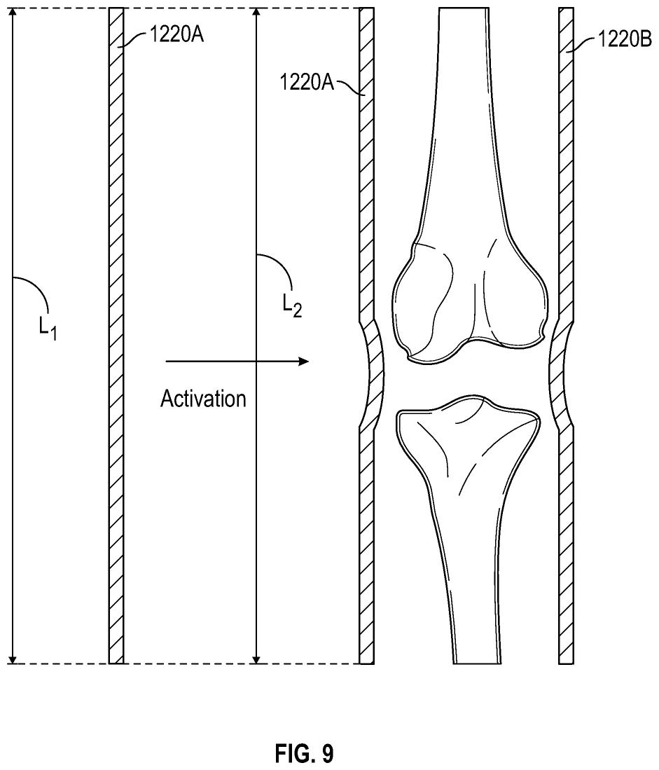

When pressurized air is introduced into the inlet port 1200, the length of the soft bodied actuator 1000 is increased. The increase in length provides a tensile force across the knee thus distracting the knee and encouraging tissue regeneration. In an embodiment, the portion of the actuator near the knee may protrude inwards towards the knee as seen in the FIG. 9. In the FIG. 9, a soft bodied brace having two opposing soft bodied actuators 1220A and 1220B of original length L₁ are held in position on a sleeve (not shown). Upon activation, the length of the soft bodied actuators increases from the original length L₁ to length L₂. The soft bodied actuators are designed to undergo a kink at the location of the knee as seen in the FIG. 9. This kink occurs in both of the soft bodied actuators 1220A and 1220B. The kink in the actuator 1220A is opposed to the kink in the actuator 1220B and the opposing kinks compress the tissue near the knee. The combined tensile force produced by the elongational force of the expanded actuators when combined with the compressive force produced at the knee facilitates distracting the knee joint with the appropriate loading and permitting for cartilage repair.

While the FIGS. 8A and 8B depict two chambers-one on each side of the central channel, it is plausible that the soft bodied actuator can comprise a series of single chambers, each of which are in communication with the central channel.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A brace for regeneration of tissue in a knee comprising:
a sleeve;
and a first strut; where the first strut comprises an upper portion comprising a first jig; where the first jig comprises a slot for hosting a first strap that is in contact with the sleeve;
a central portion that comprises a central strut that is in fluid communication with an actuator located on a first side of the knee that imposes a force on the knee; where the force is inclined at an angle to a longitudinal axis of the first strut; and
a lower portion that comprises a second jig; where the second jig comprises a slot for hosting a second strap that contacts the sleeve at an opposite end relative to a position that the first strap contacts the sleeve.

2. The brace of claim 1, further comprising a second strut that lies opposite the first strut; where the where the second strut also comprises a central portion that comprises a central strut in fluid communication with an actuator located on a second side of the knee that imposes a force on the knee; where the force is inclined at an angle to a longitudinal axis of the second strut; where the actuator on the second side of the knee applies a force that is opposed to the force applies by the actuator on the first side of the knee.

3. The brace of claim 1, where the first jig is in contact with an actuator chamber that contains an actuator that increases a length of the first strut; where the actuator contained in the actuator chamber imposes a force along the longitudinal axis of the strut.

4. The brace of claim 2, where the second strut also comprises an upper portion that is in communication with the central portion, where the upper portion comprises a jig and an actuator contained in an actuation chamber; where the actuator imposes a force along the longitudinal axis of the strut.

5. The brace of claim 1, where the actuator located on the first side of the knee comprises an actuator bladder that is contained in an actuator shell; where the actuator bladder is activated by pressurized air.

6. The brace of claim 5, where the actuator shell comprises a central passage through which the actuator bladder protrudes.

7. The brace of claim 6, where the actuator shell is reversibly attached to the central strut and where the central strut comprises a port for the pressurized air and wherein the port is in fluid communication with the actuator bladder.

8. The brace of claim 1, where the central portion can swivel about the upper portion and/or the lower portion of the first strut.

9. The brace of claim 7, where the actuator bladder comprises an elastomer.

10. The brace of claim 9, where the elastomer comprises a polysiloxane, a polybutadiene, a polyisoprene, a styrene-butadiene rubber, a poly(styrene)-block-poly(butadiene), a poly(acrylonitrile)-block-poly(styrene)-block-poly(butadiene) (ABS), a polychloroprene, an epichlorohydrin rubber, a polyacrylic rubber, a fluorosilicone elastomer, a fluoroelastomer, a perfluoroelastomer, a polyether block amide (PEBA), a chlorosulfonated polyethylene, an ethylene propylene diene rubber (EPR), an ethylene-vinyl acetate elastomer, or a combination thereof.

11. The brace of claim 9, where the elastomer comprises a polysiloxane, a perfluoroelastomer, a fluoroelastomer, or a combination thereof.

12. The brace of claim 1, where the upper portion, the central portion and the lower portion all comprise at least one structural member that is rigid.

13. A brace for regeneration of tissue in a knee comprising:
a sleeve;
at least two a soft bodied actuators; where the two soft bodied actuators are located on diametrically opposing sides of the sleeve; where the ends of each soft bodied actuators are located at the opposing longitudinal ends of the sleeve;
where each soft bodied actuator comprises an elastomer; where each soft bodied actuator comprises a plurality of chambers; where each chamber comprises an internal cavity that is in fluid communication with a central channel and where the central channel is in fluid communication with an inlet port; where the length of the soft bodied actuator is increased by increasing the internal air pressure inside the plurality of chambers.

14. The brace of claim 13, where the soft-bodied actuators each comprise an elastomer.

15. The brace of claim 13, where the walls of the central channel comprise a non-retractable material.
